(19) United States
(12) Patent Application Publication
(10) Pub. No.: US 2011/0163941 A1
(43) Pub. Date: Jul. 7, 2011

(54) LED PANEL

(76) Inventor: Eric Li, Milpitas, CA (US)

(21) Appl. No.: 13/041,427

(22) Filed: Mar. 6, 2011

(51) Int. Cl. G09G 3/32

(52) U.S. Cl. 345/83

(57) ABSTRACT

An LED panel system comprises a plurality of LEDs arranged into an LED array with rows and columns, each LED having an anode and a cathode, wherein the LEDs are of the same color or of different colors. The LED panel system has a plurality of common cathode nodes, each common cathode node connecting cathodes of the LEDs in a same row; a plurality of common anode nodes, each common anode node connecting anodes of the LEDs of a same color in a same column; and a plurality of power sources, each power source supplying electric power to at least one common anode node.

### FIELD OF THE INVENTION

The present invention relates generally to an LED panel and methods for powering an LED panel, particularly to circuitries and methods that reduce the power consumption of the LED panel.

### BACKGROUND

Light-emitting diodes (LEDs) are used in various display devices, such as in pixel RGB displays or in backlighting devices for LCD displays. In display devices, LEDs are often arranged into arrays having rows and columns. One element in the array is located at each intersection of rows and columns, forming pixels of the LED display. The element, i.e., the pixels in an LED display, can be composed of a single LED or a plurality of LEDs of the same or different colors in a cluster. Therefore, it is desirous to reduce the size of LEDs to improve the resolution of the LED display, for example, to a pixel pitch of 2 mm by 2 mm or smaller.

In this application, an RGB LED unit refers to a cluster of LEDs having a red LED, a green LED, and a blue LED. RGB LED units are often used to form a pixel in an LED display. Surface mounted RGB LED units usually have four pins, one pin for each of the red, green, and blue LEDs and another pin for either a common anode or a common cathode. LED arrays are often arranged in common anode configurations and use an NMOS driver as the current sink. An NMOS is preferable over a PMOS since NMOS has a larger current capacity and a lower Rds(on) for a given size. In a common anode configuration, all RGB LEDs are connected to the same power supply and have a same supply voltage. As is well known in the art, the red LED forward voltage is significantly lower than that of green and blue LEDs. The red, green, and blue LEDs using the same supply voltage means that a significant amount of energy is released as heat. For example, if the supply voltage is 5 volts, since the forward voltage drop of a red LED is about 2.0 volts, about 60% of the energy is lost as heat.

### BRIEF SUMMARY OF THE DISCLOSURE

According to one embodiment of the current disclosure, an LED panel system comprises a plurality of LEDs arranged into an LED array with rows and columns, each LED having an anode and a cathode, wherein the LEDs are of the same color or of different colors. The LED panel system has a plurality of common cathode nodes, each common cathode node connecting cathodes of the LEDs in a same row; a plurality of common anode nodes, each common anode node connecting anodes of the LEDs of a same color in a same column; and a plurality of power sources, each power source supplying electric power to at least one common anode node.

According to a further embodiment of the current disclosure, the LED array comprises a single LED or a cluster of LEDs of a same color or different colors. The cluster of LEDs can be an RGB LED unit, which comprises a red LED, a green LED, and a blue LED.

According to still another embodiment of the current disclosure, the LEDs in the same row of the LED array have their cathodes connected to a common cathode node. When the LED array is composed of single LEDs, the anode of the LEDs in a same column are connected to a common anode node. When the LED array is composed of RGB LED units, the anodes of red LEDs in a same column are connected to a red LED common anode node, the anodes of green LEDs in a same column are connected to a green LED common anode node, and the anodes of blue LEDs in a same column are connected to a blue LED common anode node.

The disclosure also provides a method of powering an LED panel. The method comprises the step of obtaining a plurality of RGB LED units, each comprising a red LED, a green LED, and a blue LED; arranging the plurality of RGB LED units into an array comprising columns and rows of RGB LED units; connecting cathodes of RGB LED units in a same row to a common cathode node; connecting anodes of red LEDs in a same column to a red LED common anode node; connecting anodes of green LEDs in a same column to a green LED common anode node; and connecting anodes of blue LEDs in a same column to a blue LED common anode node.

The method of the current disclosure further includes the steps of connecting the red LED common anode node to a first constant current driver; connecting the green LED common anode node to a second constant current driver; and connecting the blue LED common anode node to a third constant current driver. While the first, second, and third constant current drivers are further powered by three different power sources, respectively. In this case, the voltage of the first power source is set at a lower value than that of the second or the third power source.

Furthermore, according to another embodiment, the first constant current driver is powered by a first power source while the second and third constant current drivers are powered by a second power source. In this case, the voltage of the first power source is set at a lower value than that of the second power source.

### BRIEF DESCRIPTION OF THE DRAWINGS

The teachings of the present invention can be readily understood by considering the following detailed description in conjunction with the accompanying drawings.

FIG. 1 is a diagram illustrating an embodiment according to the current disclosure.

FIG. 2 is a diagram illustrating another embodiment according to the current disclosure.

FIG. 3 is a timing diagram for the embodiments shown in FIG. 1 and FIG. 2.

### DETAILED DESCRIPTION

The Figures (FIG.) and the following description relate to the preferred embodiments of the present invention by way of illustration only. It should be noted that from the following discussion, alternative embodiments of the structures and methods disclosed herein will be readily recognized as viable alternatives that may be employed without departing from the principles of the claimed inventions.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

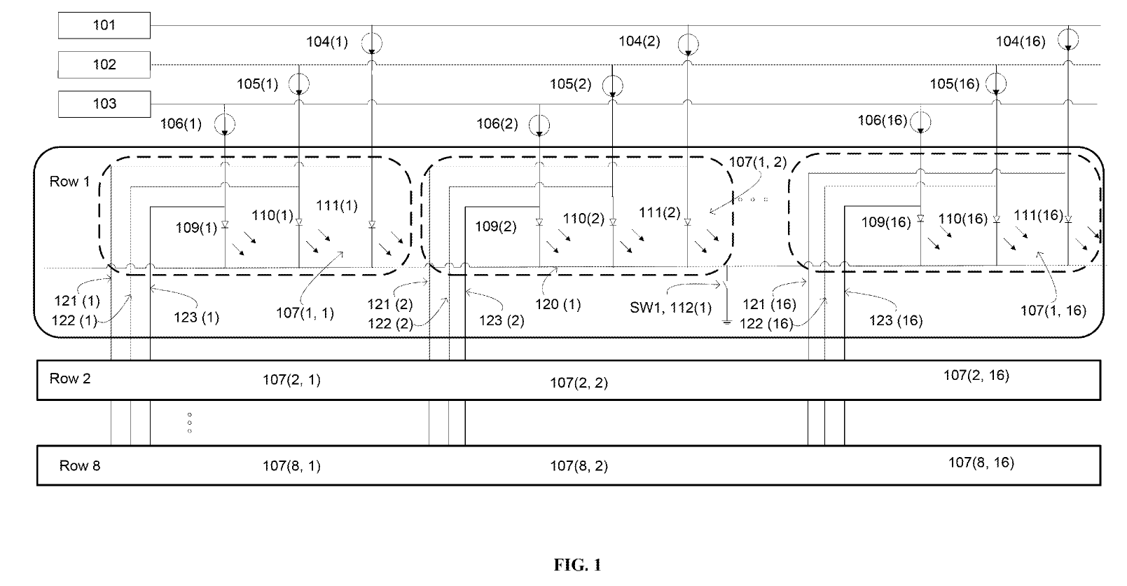

FIG. 1 is a diagram illustrating an LED panel system according to one embodiment of the current disclosure. The LED array in the LED panel system comprises an 8×16 matrix of RGB LED units 107, power sources 101, 102, and 103, and a plurality of constant current drivers 104, 105, and 106.

The RGB LED unit 107 comprises a red LED 109, a green LED 110, and a blue LED 111 packaged into one integrated part. The RGB LED unit 107 has four output pins, one of which is a common cathode pin (i.e., the shared cathode for the red, green, and blue LEDs), the other three are the anodes of red, green and blue LEDs. The common cathode pin is connected to a common cathode node 120. As shown in FIG. 1, the common cathodes node 120 connects the cathodes of the RGB LED units in a same row.

The anodes of red LEDs in a same column of the matrix are connected to a common anode node 121 (“the red LED common anode node”), which is connected to constant current driver 104. The driver 104 in turn is powered by the power source 101(P_{Red}), having a voltage V_{DD}_{_{—}}_{Red}. The anodes of green LEDs in the same column of the matrix are connected to a common anode node 122 (“the green LED common anode node”), which is connected to constant current driver 105. The driver 105 is connected to the power source 102 (P_{Green}), having a voltage V_{DD}_{_{—}}_{Green}. Likewise, the anodes of blue LEDs in the same column of the matrix are connected to a common anode node 123 (P_{Blue}), which is connected to constant current driver 106. The driver 106 is further connected to the power source 103, having a voltage V_{DD}_{_{—}}_{Blue}. In this application, a “path” or an “LED path” starts at a power source and travels through only one common anode node and LEDs connected to that common anode node.

In the configuration depicted in FIG. 1, the voltages for power sources 101, 102, and 103 can be individually set in accordance with the different forward voltages of the red, green, and blue LEDs—V_{F-Red}, V_{F-Green}, and V_{F-Blue},—respectively. The V_{DD} of a particular path can be expressed in the following general formula:

V_{DD}=N*V_{F}+V_{DSP}+V_{DSN}

wherein N stands for the number of LEDs in a same common anode node, V_{DSP} stands for the voltage between the drain and source of a PMOS that is in the same path with the common anode node, and V_{DSN} stands for the voltage between the drain and source of an NMOS that is in the same path with the common anode node. In this case, V_{F} represents the mathematical average of the forward voltage of all LEDs that are connected to the common anode node.

When V_{DSP} and V_{DSN} for various red, green, or blue LED paths (i.e., paths comprise the red common anode node, the green common anode node, or the blue common anode node) are of a same or similar value, and each LED path has N number of LEDs, and the LEDs in the same path have the same forward voltage, the following relationships are true:

V_{DD}_{_{—}}_{Blue}−V_{DD}_{_{—}}_{Red}=N(V_{F Blue} V_{F}_{_{—}}_{Red})

V_{DD}_{_{—}}_{Green}−V_{DD}_{_{—}}_{Red}=N(V_{F Green} V_{F}_{_{—}}_{Red})

For LEDs used in small pitch applications, e.g., high resolution displays, V_{F-Red} ranges from 1.8 volts to 2.4 volts while V_{F-Green} and V_{F-Blue} range from 2.6 volts to 3.6 volts. The differences among the forward voltages allow one to chose V_{DD} based on the forward voltage of LEDs in a particular LED path. In contrast, in configurations where one power source supplies the whole array of LEDs, all the anodes of the LEDs are conductively connected to the same power source (sometime referred to as “common anode”), V_{DD} is the same for all LEDs paths. The voltage overhead on the red LED paths is wasted.

By using different power sources for red, green, and blue LEDs, one may select a power supply voltage that closely matches the forward voltage of LEDs of a specific color. Consequently, the red LED may use a power supply voltage lower than that of the green or the blue LED, reducing the power consumption in the red LED path.

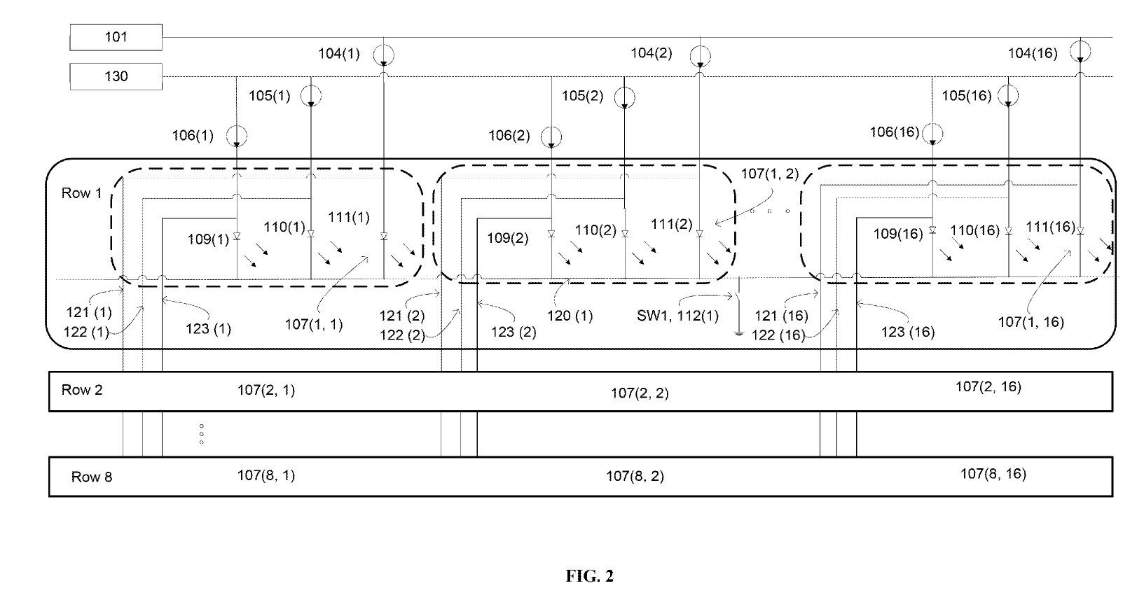

FIG. 2 shows another embodiment according to the current disclosure. The same numerals in FIG. 1 and FIG. 2 refer to the same components or devices. In the embodiment of FIG. 2, the power source 130 (P_{GB}) supplies voltage V_{DD-GB} for both the green LED common anode nodes and the blue LED common anode nodes. In this configuration, only two power sources are required to power the RGB LED units, one for powering the red LEDs, the other for powering both the green and the blue LEDs.

In both FIG. 1 and FIG. 2, switches SW1, labeled as “SW1, 112(1),” to SW8 (not shown) are scan switches connecting the common cathode node of different rows and a grounding means. The switches are normally open. When the scan switch is closed (“on” position), it grounds the common cathode node it connects to, activating the row of LEDs sharing the same common cathode node. These scan switches usually are not turned on simultaneously but are turned on following certain sequences. Accordingly, the rows of LEDs that are connected to the scan switches are turned on following the same sequences.

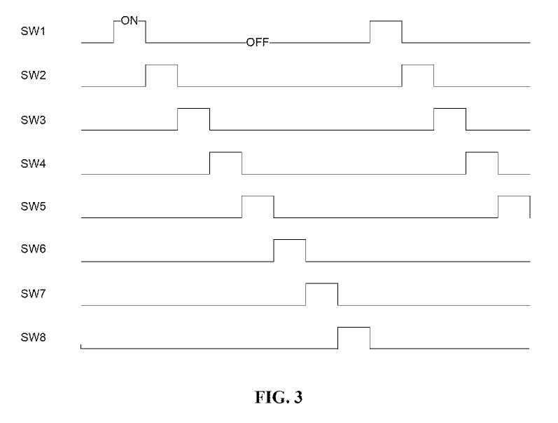

FIG. 3 shows a timing diagram of SW1 to SW8 according to the embodiments either FIG. 1 or FIG. 2. According to this timing diagram, switch SW1 is turned on for a period of time Δ_on, then at the end of Δ_on period, SW1 is turned off and SW2 is turned on, then for the same period of time Δ_on, SW2 remains on during that period, then at the second end of Δ_on period, SW2 is turned off and SW3 is turned on for the same period of time Δ_on, SW3 remains on during that period, then at the third end of Δ_on period, SW3 is turned off, etc., until at the end of the seventh end of Δ_on period, SW7 is turned off and SW8 is turned on for the same period of time Δ_on. Therefore, only one among SW1 to SW8 are on at any one time and each of the SW1 to SW8 have the same duty cycle.

Consequently, no more than one scan switch is on at any given time. Therefore, the constant current driver supplies only one row of RGB LED units at any given time. Thus the capacity of the constant current driver and so its cost can be significantly reduced. If the scan frequency is high enough, human eyes are not able to discern the ON/OFF states and the visual quality is not affected.

Many variations of the above described embodiments are available. For example, a pixel of the LED panel may be composed of one RGB LED unit, or several LEDs of the same or different colors (e.g., white, yellow, or any color LEDs available on the market). The LEDs in different pixels may also have the same or different colors.

The array of LEDs can be arranged into a variety of geometric shapes, either two-dimensional such as rectangular or circular, or three-dimensional such as cylindrical or spherical. In LED displays, when LEDs are used as pixels, the distances between two adjacent pixels in the same row can be same or different. Likewise, the distances between two adjacent pixels can be same or different.

The LED array disclosed herein can be readily scaled up. The LED array can have many rows and columns, e.g., 256 rows by 256 columns. Such LED arrays can be used as an LED display panel by themselves or used as a sub-module in a large LED display panel. For example, an LED display panel can be composed of 120×135 sub-modules of the 16×8 LED arrays, resulting in a resolution of 1920×1080.

Furthermore, the LED panels disclosed herein can also be used in a backlighting device for an LCD display, or in other circumstances to display images or to provide backlight.

Although the present invention has been described above with respect to several embodiments, various modifications can be made within the scope of the present invention. Accordingly, the embodiments disclosed herein are intended to be illustrative, but not limiting, of the scope of the invention, which is set forth in the following claims.

What is claimed is:

1. An LED panel system, comprising:
a plurality of LEDs arranged into an LED array with rows and columns, each LED having an anode and a cathode, wherein the LEDs are of the same color or of different colors;
a plurality of common cathode nodes, each connected with cathodes of the LEDs in a same row;
a plurality of common anode nodes, each connected with anodes of the LEDs of a same color in a same column; and
a plurality of power sources, each supplying electric power to at least one common anode node.

2. The LED panel system of claim 1, wherein an element of the LED array is a single LED, all anode of the LEDs in a column are connected to a common anode node while the cathodes of all LEDs in a row are connected to a common cathode node.

3. The LED panel system of claim 1, wherein an element of the LED array is a cluster of LEDs of a same or different colors.

4. The LED panel system of claim 3, wherein the cluster of LEDs is an RGB LED unit having a red LED, a green LED, and a blue LED,
wherein the anodes of red LEDs in a same column are connected to a red LED common anode node,
wherein the anodes of green LEDs in a same column are connected to a green LED common anode node,
wherein the anodes of blue LEDs in a same column are connected to a blue LED common anode node, and
wherein the cathodes of all LEDs in a same row are connected to a common cathode node.

5. The LED panel system of claim 4, wherein the a power source P_{Red} supplies electric power to at least one red LED common anode node, a power source P_{Green} supplies electric power to at least one green LED common anode node, and a power source P_{Blue} supplies electric power to at least one blue LED common anode node.

6. The LED panel system of claim 5, wherein assuming a number of red LEDs connected to the red LED common anode node, a number of green LEDs connected to the green LED common anode node, and a number of blue LEDs connected to the blue LED common anode node have the same value N, the following equations are true:
V_{DD}_{_{—}}_{Blue}−V_{DD}_{_{—}}_{Red}=N(V_{F}_{_{—}}_{Blue}−V_{F-Red})
V_{DD}_{_{—}}_{Green}−V_{DD}_{_{—}}_{Red}=N(V_{F}_{_{—}}_{Green}−V_{F-Red})
wherein V_{DD}_{_{—}}_{Red}, V_{DD}_{_{—}}_{Green}, and V_{DD}_{_{—}}_{Blue} are respectively the voltages of P_{Red}, P_{Green}, and P_{Blue}, wherein V_{F-Red}, V_{F-Green}, and V_{F-Blue} are respectively the mathematical average of forward voltages of red, green, and blue LEDs in the LED panel system.

7. The LED panel system of claim 6, wherein V_{F-Red} ranges from 1.8 volts to 2.6 volts, while V_{F-Green} and V_{F-Blue} both range from 2.6 volts to 3.6 volts.

8. The LED panel system of claim 5, wherein P_{Green} and P_{Blue} are the same power source, which supplies electric power to both the green LED common anode nodes and the blue LED common anode nodes.

9. The LED panel system of claim 4, further comprising a plurality of scan switches, each connects a common cathode node to the ground.

10. The LED panel system of claim 9, wherein the plurality of scan switches are controlled such that only one scan switch is closed at any given time.

11. The LED panel system of claim 4, wherein distances between two adjacent RGB LED units in a same row are same or different, and distances between two adjacent RGB LED units in a same column are same or different.

12. The LED panel system of claim 1, wherein the LED panel system is used in an LCD display.

13. The LED panel system of claim 4, wherein the LED panel system is used in a backlighting device for an LCD display.

14. The LED panel system of claim 1, wherein the LED array is in a geometric shape that is rectangular, circular, cylindrical, or spherical.

15. A method for powering an LED panel, comprising:
obtaining a plurality of RGB LED units, each comprising a red LED, a green LED, and a blue LED;
arranging the plurality of RGB LED units into an array comprising columns and rows of RGB LED units;
connecting cathodes of RGB LED units in a same row to a common cathode node;
connecting anodes of red LEDs in a same column to a red LED common anode node;
connecting anodes of green LEDs in a same column to a green LED common anode node;
connecting anodes of blue LEDs in a same column to a blue LED common anode node;
connecting the red LED common anode node to a first constant current driver;
connecting the green LED common anode node to a second constant current driver; and
connecting the blue LED common anode node to a third constant current driver.

16. The method of claim 15, further comprising:
connecting the first constant current driver to a first power source;
connecting the second and third constant current driver to a second power source;
setting a voltage of the first power source lower than a voltage of the second power source.

17. The method of claim 15, further comprising:
connecting the first constant current driver to a first power source;
connecting the second constant current driver to a second power source_{;}
connecting the third constant current driver to a third power source; and
setting a voltage of the first power source lower than either a voltage of the second power source or a voltage of the third power source.
